(19) United States
(12) Patent Application Publication
(10) Pub. No.: US 2025/0307193 A1
(43) Pub. Date: Oct. 2, 2025

(54) Docking Station and Data Transmission

(71) Applicant: Anker Innovations Technology Co., Ltd., Changsha (CN)

(72) Inventor: Yongjun Chen, Shenzhen (CN)

(21) Appl. No.: 19/088,176

(22) Filed: Mar. 24, 2025

(30) Foreign Application Priority Data
Mar. 27, 2024 (CN) 202410361709.8

(51) Int. Cl. G06F 13/38; G06F 1/16

(52) U.S. Cl. CPC G06F 13/38; G06F 1/1632; G06F 2213/40

(57) ABSTRACT

A data transmission method may comprise obtaining an initial transmission mode of a docking station connected to a host. The data transmission method may further comprise obtaining device information of a computing device connected to a port on the docking station, and obtaining a data transmission mode of the port based on the initial transmission mode and the device information of the computing device. In addition, the data transmission method may comprise sending an instruction to the host to transmit, based on the data transmission mode of the port, data from the host device to the computing device.

### CROSS-REFERENCE OF RELATED APPLICATION

The present application claims priority to CN202410361709.8, filed on Mar. 27, 2024, which is incorporated by reference by its entirety.

### TECHNICAL FIELD

The present application relates to the technical field of data transmission, in particular to a data transmission method and apparatus, and a docking station.

### BACKGROUND

A docking station (e.g., a hub) is a port extension device, which can achieve one-station connection between a host and a plurality of external devices (such as a power adapter and a display device). As the number of external devices supporting Type-C ports increase, the docking station correspondingly includes a universal serial bus hub (USB HUB) to extend one USB Type-C port into more.

In practical applications, the docking station usually transmits data to the connected external devices by using a fixed data transmission mode. However, different types of external devices are adapted to different data transmission modes. As a result, the docking station has poor compatibility with different types of external devices, which affects the data transmission quality of the external devices.

### SUMMARY

In view of the above technical problems, the application provides data transmission methods and apparatuses.

In a first aspect, the present application provides a data transmission method. The data transmission method may comprise obtaining an initial transmission mode of a docking station connected to a host. The data transmission method may further comprise obtaining device information of a computing device (e.g., a display device) connected to a port on the docking station, and obtaining a data transmission mode of the port based on the initial transmission mode and the device information of the computing device. In addition, the data transmission method may comprise sending an instruction to the host to transmit, based on the data transmission mode of the port, data from the host device to the computing device.

In one example, the determining the data transmission mode of the port based on the initial transmission mode and the device information of the computing device comprises: determining a device type of the computing device based on the device information of the computing device; and determining the data transmission mode of the port based on the device type of the computing device and the initial transmission mode.

In one example, the determining the data transmission mode of the port based on the device type of the computing device and the initial transmission mode comprises: determining an adapted transmission mode of the computing device based on the device type of the computing device; and determining, for the computing device, the data transmission mode of the corresponding port based on the adapted transmission mode and the initial transmission mode.

In one example, the determining an adapted transmission mode of the computing device based on the device type of the computing device comprises: determining a data transmission requirement of the computing device based on the device type of the computing device; and determining the adapted transmission mode of the computing device based on the data transmission requirement of the computing device.

In one example, the determining a data transmission requirement of the computing device based on the device type of the computing device comprises: determining that the data transmission requirement of the computing device is a low data transmission volume based on determining that the computing device is a non-display device, and/or obtaining the number of transmission channels from the device information of the computing device based on determining that the computing device is a display device, and determining the data transmission requirement based on the number of transmission channels.

In one example, the determining the data transmission requirement based on the number of transmission channels comprises: determining that the data transmission requirement is the low data transmission volume based on that the number of transmission channels is less than a preset number, and/or determining that the data transmission requirement is a high data transmission volume when the number of transmission channels is greater than or equal to the preset number, where the high data transmission volume is greater than the low data transmission volume.

In one example, the adapted transmission mode includes a first display data transmission mode and a second display data transmission mode. The data transmission volume of the second display data transmission mode is greater than that of the first display data transmission mode. The determining the adapted transmission mode of the computing device based on the data transmission requirement of the computing device comprises: determining that the adapted transmission mode is the first display data transmission mode based on determining that the data transmission requirement of the comprises device is the low data transmission volume, and/or determining that the adapted transmission mode is the second display data transmission mode based on determining that the data transmission requirement of the computing device is the high data transmission volume.

In one example, the determining the data transmission mode of the corresponding port based on the adapted transmission mode and the initial transmission mode comprises: maintaining the initial transmission mode as the data transmission mode of the corresponding port when the adapted transmission mode is the same as the initial transmission mode, and/or switching the initial transmission mode to the adapted transmission mode when the adapted transmission mode is different from the initial transmission mode, and designating the adapted transmission mode as the data transmission mode of the corresponding port.

In a second aspect, the present application further provides a data transmission apparatus, comprising one or more processors and memory storing instructions that, when executed by the one or more processors, cause the apparatus to obtain an initial transmission mode of a docking station connected to a host device; obtain device information of a computing device connected to a port of the docking station; determine a data transmission mode of the port based on the initial transmission mode and the device information of the computing device; and send an instruction to the host device to transmit, based on the data transmission mode of the port, data from the host device to the computing device.

In a third aspect, the present application further provides a docking station, including a charging controller, a USB hub, and a memory, the memory storing a computer program. The charging controller, when executing the computer program, implements the steps of the method in any of the above.

In the data transmission method and apparatus, and the docking station, the initial transmission mode of the docking station after being connected to the host is obtained, the device information of an external device (e.g., a computing device) connected to the at least one port on the docking station is obtained, and the data transmission mode of the port is determined based on the initial transmission mode and the device information of the external device, so as to instruct the host to transmit data to the connected external device through the data transmission mode of the port. In the method, the data transmission mode of the port can be determined comprehensively based on the initial transmission mode of the docking station and the device information of the external device connected to the port, so as to adapt to different external devices, improve device compatibility, and thereby improve the data transmission quality of the external devices. Especially when the external device is a display device, the method can ensure the display effect of the display device with multiple resolutions, and can avoid the deterioration of the display effect caused by bandwidth halving.

### BRIEF DESCRIPTION OF THE DRAWINGS

FIG. 1 is a diagram showing an application environment of a data transmission method;

FIG. 2 is a schematic diagram of an internal structure of a docking station;

FIG. 3 is a schematic flowchart of a data transmission method;

FIG. 4 is a schematic flowchart of determining a data transmission mode;

FIG. 5 is a schematic flowchart of determining a data transmission mode;

FIG. 6 is a schematic flowchart of determining an adapted transmission mode;

FIG. 7 is a schematic flowchart of determining a data transmission requirement;

FIG. 8 is a schematic flowchart of determining a data transmission requirement;

FIG. 9 is a schematic flowchart of determining an adapted transmission mode;

FIG. 10 is a schematic flowchart of determining a data transmission mode;

FIG. 11 is a schematic flowchart of a data transmission method;

FIG. 12 is a schematic flowchart of controlling an initial transmission mode; and

FIG. 13 is a structural block diagram of a data transmission apparatus.

### DETAILED DESCRIPTION

In order to make the objectives, technical solutions, and advantages of the present application clearer, the following further describes the present application in detail in conjunction with the accompanying drawings and examples. It is to be understood that the specific examples described herein are only used for explaining the present application, and are not used for limiting the present application.

A data transmission method can be applied to an application environment shown in FIG. 1. A docking station 200 is connected to a host 100 through, for example, an upstream facing port (UFP), and connected to an external device 300 through, for example, a downstream facing port (DFP), to achieve data transmission between the host 100 and the external device 300. The host 100 may be one or more of various personal computers, notebook computers, smart phones, tablets, Internet of things devices, or portable wearable devices. The external device 300 may be one or more of various display devices, adapters, or storage devices.

In one example, the docking station 200 comprises: a charging controller, a USB hub, an UFP, a DFP, and multiplexers. The UFP is connected to the USB hub and the host. The DFP is connected to the USB hub and the external device, so as to connect the external device to the host through the USB hub. The UFP and the DFP are also connected to the USB hub through the multiplexers. The charging controller is connected to the UFP, the DFP and the multiplexers, respectively.

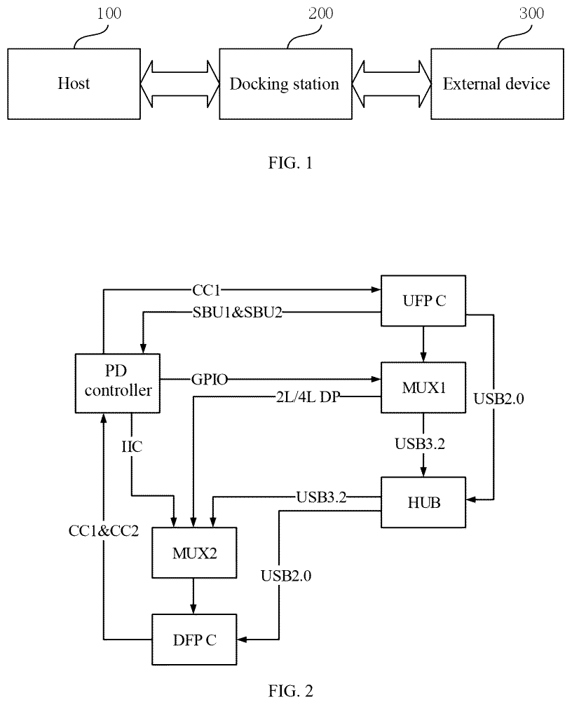

Taking the docking station 200 applicable to a Type-C port on the host 100 as an example, its internal structure is shown in FIG. 2, including a USB power delivery (PD) controller, a USB hub, a Type-C UFP (UFP C in FIG. 2), a Type-C DFP (DFP C in FIG. 2), and multiplexers (MUXs). The docking station 200 is connected to the host 100 through the UFP C and connected to the external device 300 through the DFP C. The UFP C can support USB 2.0 with the USB HUB and support USB 3.2 through the MUX1, and the DFP C can support USB 2.0 with the USB HUB and support USB 3.2 through the MUX2.

The PD controller can be connected to the UFP C through a configuration channel (CC), and can detect forward and reverse insertion into the Type-C port on the host 100, establish and manage a connection with a voltage bus (VBUS) in the host 100, and transmit non-USB signals (such as audio signals) based on side band use (SBU). The PD controller communicates with the MUX1 through general purpose I/O ports (GPIO), to switch between different data transmission modes by controlling the MUX1 and the MUX2 and output data to the DFP C. In FIG. 2, 2L DP represents a 2-line high-definition digital display port (DP) mode, corresponding to a first display data transmission mode with a relatively low DP data transmission volume; and 4L DP represents a 4-line high-definition digital display port mode, corresponding to a second display data transmission mode with a relatively high DP data transmission volume. The PD controller is connected to the DFP C through a CC1 and a CC2, can be configured to detect whether the DFP C is connected to the external device 300, and communicates with the MUX2 through an inter-integrated circuit (IIC) port.

Those skilled in the art can understand that the structure shown in FIG. 2 may be only a block diagram of a partial structure of a docking station. The specific docking station may include more or fewer components than shown in the figure, or combine some components, or have a different arrangement of components.

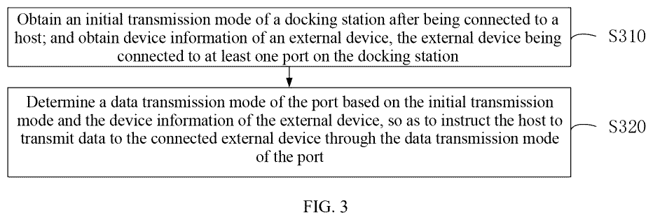

In one example, as shown in FIG. 3, a data transmission method is provided. The method may be performed by, for example, the PD controller in the docking station in FIG. 2, and may include the following steps:

S310. Obtain an initial transmission mode of a docking station after being connected to a host, and obtain device information of an external device, the external device being connected to at least one port on the docking station.

The docking station is connected to the host. The docking station is powered on via the host or via a connection to a power source. The initial transmission mode is a data transmission mode stored before the external device is connected to the docking station each time. The data transmission mode may be represented by a status flag. For example, the status flag is a Flag value. Flag=1 represents a data transmission mode with a relatively high data transmission volume, such as a 4 Lanes DP transmission mode. Flag-0 represents a data transmission mode with a relatively low data transmission volume, such as a 2 Lanes DP+USB 3.0 transmission mode. In DP1.2 standards, 2 Lanes can achieve a display effect of 4K30 Hz, while 4 Lanes can achieve a display effect of 4K60 Hz.

After the docking station is connected to the host, the PD controller can read the Flag value stored in a storage unit of the docking station, to determine the data transmission mode corresponding to the Flag value as the initial transmission mode.

For example, when the external device is connected to at least one port on the docking station, the PD controller may obtain the device information of the connected external device through the port connected to the external device. For example, when the external device is connected to the at least one DFP in the USB HUB of the docking station, the PD controller can read the device information of the connected external device through the DFP. The device information of the external device includes attribute information of the external device. For example, the device information may include a device type and device operating parameters.

S320. Determine a data transmission mode of the port based on the initial transmission mode and the device information of the external device, and instruct the host to transmit data to the connected external device through the data transmission mode of the port.

For example, after obtaining the initial transmission mode and the device information of the connected external device, the PD controller can determine, based on the device information of the external device, whether the initial transmission mode is adapted to the external device (e.g., is suitable for the external device), and determine, based on the adaptation result, the data transmission mode of the port connected to the external device, and instruct the host to transmit data to the connected external device through the data transmission mode of the port. For example, port 1 in the USB HUB of the docking station is connected to a monitor, the PD controller determines that the data transmission mode of port 1 is a 4 Lanes DP transmission mode, and send the 4 Lanes DP transmission mode to the host. The host reads (e.g., receives information indicating) the 4 Lanes DP transmission mode of port 1, and transmit data in the 4 Lanes DP transmission mode to the monitor connected to port 1.

In an example of the present application, the initial transmission mode of the docking station after being connected to the host is obtained, the device information of the external device connected to the at least one port on the docking station is obtained, and the data transmission mode of the port is determined based on the initial transmission mode and the device information of the external device, so as to instruct the host to transmit data to the connected external device through the data transmission mode of the port. In the above method, the data transmission mode of the port can be determined comprehensively based on the initial transmission mode of the docking station and the device information of the external device connected to the port, so as to adapt to different external devices, improve device compatibility, and thereby improve the data transmission quality of the external devices. If the external device is a display device, the above method can ensure the display effect of the display device with multiple resolutions, and can avoid the deterioration of display effects of some display devices caused by bandwidth halving due to the fixed use of a 2Lanes DP+USB3.0 transmission mode.

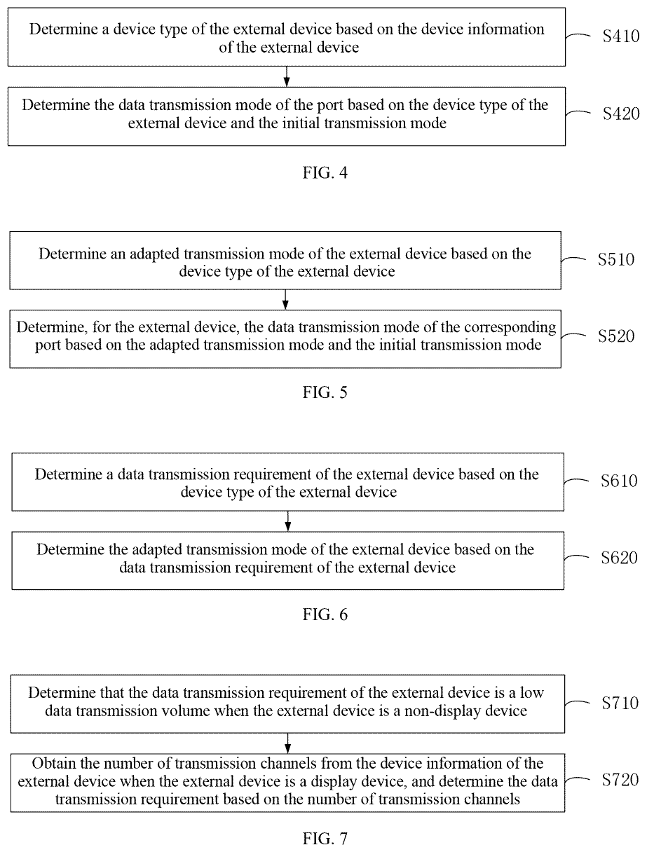

The device information includes a device type. On this basis, in one example, as shown in FIG. 4, S320 determining a data transmission mode of the port based on the initial transmission mode and the device information of the external device may include the following steps:

S410. Determine a device type of the external device based on the device information of the external device.

The device type may be represented by a type identifier. For example, after the external device is connected to the port on the docking station, the PD controller can read the device information of the connected external device through the port, and extract the type identifier that represents the device type to determine the device type of the connected external device. For example, if the type identifier read (e.g., received) by the PD controller is monitor, it is determined that the device type is a display device.

S420. Determine the data transmission mode of the port based on the device type of the external device and the initial transmission mode.

For example, after obtaining the device type of the connected external device, the PD controller can determine whether the device type of the external device is adapted to the initial transmission mode, so as to determine the data transmission mode of the corresponding port based on the adaptation result.

Different types of external devices are adapted to different data transmission modes. In an example, as shown in FIG. 5, S420 determining the data transmission mode of the port based on the device type of the external device and the initial transmission mode may include the following steps:

S510. Determine an adapted transmission mode of the external device based on the device type of the external device.

The adapted transmission mode is a data transmission mode that can meet a corresponding data transmission requirement of the external device.

For example, the docking station pre-stores corresponding relationships between different device types and adapted transmission modes. After obtaining the device type of the connected external device, the PD controller can read the pre-stored corresponding relationships, and determine the adapted transmission mode corresponding to the device type of the external device based on the corresponding relationships, so as to obtain the adapted transmission mode of the external device.

S520. Determine, for the external device, the data transmission mode of the corresponding port based on the adapted transmission mode and the initial transmission mode.

For example, for the external device connected to the docking station, the PD controller can compare the adapted transmission mode of the external device with the initial transmission mode, and determine the data transmission mode of the corresponding port, so as to control the initial transmission mode.

In an example of the present application, the device type of the external device is determined based on the device information of the external device, and then the data transmission mode of the port is determined based on the device type of the external device and the initial transmission mode. Specifically, the adapted transmission mode of the external device can be determined based on the device type of the external device, and the data transmission mode of the corresponding port can be determined for the external device based on the adapted transmission mode and the initial transmission mode. In the above method, the adapted transmission mode of the external device can be accurately determined based on the device type of the connected external device, and the data transmission mode of the corresponding port can be determined based on the initial transmission mode and the adapted transmission mode of the external device, so as to adapt to different types of external devices, improve compatibility with multiple types of external devices, and correspondingly improve data transmission quality.

The adapted transmission mode of the external device can be determined based on a data transmission requirement of the external device. On this basis, in one example, as shown in FIG. 6, S510, determining an adapted transmission mode of the external device based on the device type of the external device may include the following steps:

S610. Determine a data transmission requirement of the external device based on the device type of the external device.

The data transmission requirement indicates, for example, a requirement of the external device for a data transmission volume. Some external devices require higher data transmission volumes, while others require lower data transmission volumes. Different types of external devices represent different data transmission requirements.

For example, after obtaining the device type of the external device, the PD controller can determine the data transmission requirement corresponding to the external device based on corresponding relationships between device types and data transmission requirements. For example, the PD controller can determine, based on preset corresponding relationships between device types and data transmission requirements, that the transmission requirement of a display device is a high data transmission volume, and that the transmission requirement of a non-display device is a low data transmission volume.

S620. Determine the adapted transmission mode of the external device based on the data transmission requirement of the external device.

Different data transmission requirements determine different adapted transmission modes. For example, the PD controller can determine, based on the data transmission requirement of the external device, the data transmission mode adapted to the data transmission requirement, as the adapted transmission mode of the external device.

The non-display device may have a relatively low data transmission requirement. The non-display device may be a PD adapter, a storage device, etc. Therefore, in an example, as shown in FIG. 7, S610 determining a data transmission requirement of the external device based on the device type of the external device may include the following steps:

S710. Determine that the data transmission requirement of the external device is a low data transmission volume based on that the external device is a non-display device.

For example, after obtaining the device type of the external device, and when determining that the external device is a non-display device, the PD controller can determine that the data transmission requirement of the external device is relatively low (e.g., determine that the data transmission requirement of the external device is a low data transmission volume). For example, when determining that the connected external device is a storage device, the PD controller determines that the data transmission requirement of the storage device is a low data transmission volume.

S720. Obtain the number of transmission channels from the device information of the external device based on that the external device is a display device, and determine the data transmission requirement based on the number of transmission channels.

The display device may be a monitor. The number of transmission channels in the device information may indicate an actual transmission requirement of the external device, and the number of transmission channels is positively correlated with the data transmission requirement. The larger the number of transmission channels, the higher the corresponding data transmission requirement. For example, the number of transmission channels may include 2 lines (e.g., 2 Lanes), and 4 lines, (e.g., 4 Lanes).

For example, after obtaining that the external device is a display device, the PD controller can further obtain the number of transmission channels from the device information of the display device, and determine the data transmission requirement of the display device based on a corresponding relationship between the number of transmission channels and the data transmission requirement. For example, based on that the number of transmission channels of the display device is 2 Lanes and the corresponding relationship, the PD controller can determine that the data transmission requirement of the display device is a low data transmission volume. Based on that the number of transmission channels of the display device is 4 Lanes and the corresponding relationship, the PD controller can determine that the data transmission requirement of the display device is a high data transmission volume.

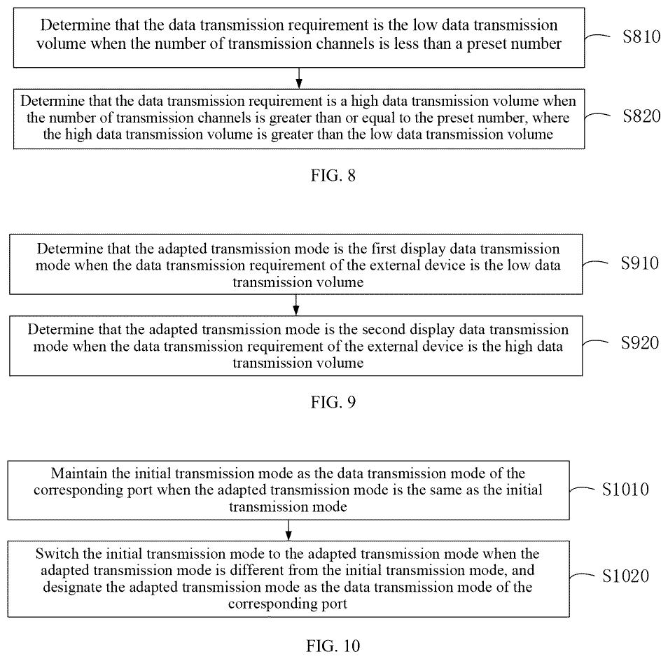

For the display device, different numbers of transmission channels correspond to different data transmission requirements. In an example, as shown in FIG. 8, S720 determining the data transmission requirement based on the number of transmission channels may include the following steps:

S810. Determine that the data transmission requirement is the low data transmission volume based on that the number of transmission channels is less than a preset number.

For example, after reading (e.g., receiving information indicating) the number of transmission channels of the display device, the PD controller can compare the number of transmission channels with the preset number to determine the corresponding data transmission requirement. Based on that the number of transmission channels is less than the preset number, the PD controller can determine that the data transmission requirement is the low data transmission volume. For example, the PD controller reads that the number of transmission channels of the display device is two lines, and the preset number is 4. Based on the comparison, the PD controller determines that the number of transmission channels 2 is less than the preset number 4, and determines that the data transmission requirement of the display device is the low data transmission volume.

S820. Determine that the data transmission requirement is a high data transmission volume based on that the number of transmission channels is greater than or equal to the preset number.

For example, the PD controller compares the read number of transmission channels with the preset number, and determines that the data transmission requirement is a high data transmission volume when the number of transmission channels is greater than or equal to the preset number. For example, the PD controller reads that the number of transmission channels of the display device is four lines, and the preset number is 4. Based on the comparison, the PD controller determines that the number of transmission channels 4 is equal to the preset number 4, and determines that the data transmission requirement of the display device is a high data transmission volume.

In an example of the present application, the data transmission requirement of the external device is determined based on the device type of the external device, and the adapted transmission mode of the external device is determined based on the data transmission requirement of the external device. Specifically, based on that the external device is a non-display device, the PD controller determines that the data transmission requirement of the external device is a low data transmission volume. Based on that the external device is a display device, the number of transmission channels is further obtained from the device information, to determine the data transmission requirement of the external device. In the above method, the device type of the external device may preliminarily reflect the actual transmission requirement of the external device. Therefore, determining the data transmission requirement based on the device type can simplify the requirement determination process and correspondingly improve processing efficiency. When the external device is a display device, the number of transmission channels in the device information can accurately reflect the actual transmission requirement of the display device, thereby correspondingly improving the accuracy of the determined data transmission requirement.

The adapted transmission mode of the external device includes a first display data transmission mode and a second display data transmission mode, and the data transmission volume of the second display data transmission mode is greater than that of the first display data transmission mode. On this basis, in one example, as shown in FIG. 9, S620 determining the adapted transmission mode of the external device based on the data transmission requirement of the external device may include the following steps:

S910. Determine that the adapted transmission mode is the first display data transmission mode based on that the data transmission requirement of the external device is the low data transmission volume.

For example, after obtaining the data transmission requirement of the external device, based on determining that the data transmission requirement of the external device is the low data transmission volume, the PD controller can determine that the adapted transmission mode of the external device is the first display data transmission mode with relatively low data transmission volume. For example, based on determining that the connected external device is a storage device, the PD controller determines that the data transmission requirement of the storage device is the low data transmission volume, and correspondingly determines that the adapted transmission mode is the first display data transmission mode, which may be specifically a 2Lanes DP+USB3.0 transmission mode.

S920. Determine that the adapted transmission mode is the second display data transmission mode when the data transmission requirement of the external device is the high data transmission volume.

For example, after obtaining the data transmission requirement of the external device, based on determining that the data transmission requirement of the external device is the high data transmission volume, the PD controller can determine that the adapted transmission mode of the external device is the second display data transmission mode with relatively high data transmission volume. For example, based on determining that the connected external device is a monitor and the number of transmission channels is 4 lanes, the PD controller determines that the data transmission requirement of the monitor is the high data transmission volume, and correspondingly determines that the adapted transmission mode is the second display data transmission mode, which may be specifically a 4Lanes DP transmission mode.

Notably, different data transmission volumes of the first display data transmission mode and the second display data transmission mode indicate different transmission volumes of DP data. The ports in the USB HUB on the docking station may be all four-line ports. The first display data transmission mode is a 2Lanes DP+USB3.0 transmission mode, that is, the port performs 2-line DP and 2-line USB 3.0 data transmission. The second display data transmission mode is a 4Lanes DP transmission mode, that is, the port performs 4-line DP data transmission.

In an example of the present application, the adapted transmission mode includes a first display data transmission mode and a second display data transmission mode, where the second display data transmission mode has a data transmission volume greater than that the first display data transmission mode. Based on that the data transmission requirement of the external device is a low data transmission volume, the PD controller can determine that the adapted transmission mode is the first display data transmission mode. Based on that the data transmission requirement of the external device is a high data transmission volume, the PD controller can determine that the adapted transmission mode is the second display data transmission mode. In the above method, an adapted transmission mode that meets an actual transmission requirement is determined based on the actual transmission requirements of different external devices, thereby improving the adaptability between the determined adapted transmission mode and the actual transmission requirement of the external device, and correspondingly improving the adaptability between the determined data transmission mode and the external device, to improve data transmission quality.

In practical applications, the adapted transmission mode of the external device can be compared with the initial transmission mode to determine the data transmission mode of the corresponding port. On this basis, in one example, as shown in FIG. 10, S520 determining the data transmission mode of the corresponding port based on the adapted transmission mode and the initial transmission mode may include the following steps:

S1010. Maintain the initial transmission mode as the data transmission mode of the corresponding port when the adapted transmission mode is the same as the initial transmission mode.

If the adapted transmission mode is the same as the initial transmission mode, this indicates that the initial transmission mode is adapted to the data transmission requirement of the corresponding external device. If the adapted transmission mode is different from the initial transmission mode, this indicates that the initial transmission mode is not adapted to the data transmission requirement of the corresponding external device.

For example, based on that the adapted transmission mode of the external device is the same as the initial transmission mode, the PD controller can determine that the initial transmission mode is adapted to the data transmission requirement of the corresponding external device, and maintain the initial transmission mode as the data transmission mode of the corresponding port.

For example, the initial Flag value read by the PD controller is 1, indicating that the initial transmission mode is the high data volume transmission mode. When the external device connected to port 1 is a high-resolution display device, the PD controller determines that the data transmission requirement of the high-resolution display device is a high data transmission volume, the adapted transmission mode is correspondingly a high data volume transmission mode, and the initial transmission mode is the same as the adapted transmission mode of the high-resolution display device. Then, the PD controller maintains the initial Flag value 1 to maintain the high data volume transmission mode as the data transmission mode of port 1.

S1020. Switch the initial transmission mode to the adapted transmission mode when the adapted transmission mode is different from the initial transmission mode, and designate the adapted transmission mode as the data transmission mode of the corresponding port.

For example, based on that the obtained comparison result shows that the adapted transmission mode is different from the initial transmission mode, the PD controller can determine that the initial transmission mode is not adapted to the data transmission requirement of the corresponding external device, switch the initial transmission mode to the adapted transmission mode, and designate the adapted transmission mode as the data transmission mode of the corresponding port.

For example, if the initial Flag value read by the PD controller is 1, this indicates that the initial transmission mode is the second display data transmission mode. When the external device connected to port 2 is a two-line display device, the PD controller determines that the data transmission requirement of the display device is a low data transmission volume, the adapted transmission mode is correspondingly the first display data transmission mode, and the initial transmission mode is different from the adapted transmission mode of the display device. Then, the PD controller sets the initial Flag value to 0, so as to switch the second display data transmission mode to the first display data transmission mode as the data transmission mode of port 2.

In an example of the present application, for the external device connected to the docking station, the adapted transmission mode of the external device is compared with the initial transmission mode. Based on that the comparison result shows that the adapted transmission mode is the same as the initial transmission mode, the initial transmission mode is maintained as the data transmission mode of the corresponding port. Based on that the comparison result shows that the adapted transmission mode is different from the initial transmission mode, the initial transmission mode is switched to the adapted transmission mode, and the adapted transmission mode is designated as the data transmission mode of the corresponding port. In the above method, the initial transmission mode can be switched based on the actual requirement of the external device to the data transmission mode adapted to the external device, thereby providing different data transmission modes for different external devices, improving device compatibility, and expanding application scope. Meanwhile, adaptive switching of different transmission modes can be implemented by means of the existing PD controller in the docking station, without setting an additional control chip, thereby reducing product design costs.

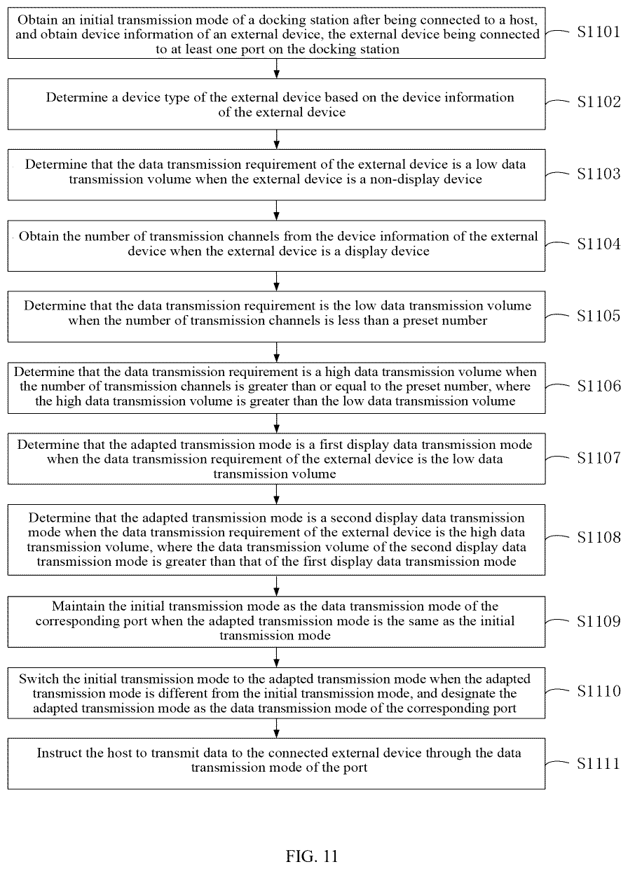

In order to facilitate the understanding of those skilled in the art, the data transmission method provided in the present application will be introduced in detail below. The method may be performed by a computing device such as the PD controller. As shown in FIG. 11, the method may include the following steps:
S1101. Obtain an initial transmission mode of a docking station after being connected to a host, and obtain device information of an external device, the external device being connected to at least one port on the docking station;
S1102. Determine a device type of the external device based on the device information of the external device;
S1103. Determine that the data transmission requirement of the external device is a low data transmission volume when the external device is a non-display device; S1104. Obtain the number of transmission channels from the device information of the external device when the external device is a display device;
S1105. Determine that the data transmission requirement is the low data transmission volume based on that the number of transmission channels is less than a preset number;
S1106. Determine that the data transmission requirement is a high data transmission volume based on that the number of transmission channels is greater than or equal to the preset number, where the high data transmission volume is greater than the low data transmission volume;
S1107. Determine that the adapted transmission mode is a first display data transmission mode based on that the data transmission requirement of the external device is the low data transmission volume;
S1108. Determine that the adapted transmission mode is a second display data transmission mode based on that the data transmission requirement of the external device is the high data transmission volume, where the data transmission volume of the second display data transmission mode is greater than that of the first display data transmission mode;
S1109. Maintain the initial transmission mode as the data transmission mode of the corresponding port based on that the adapted transmission mode is the same as the initial transmission mode;
S1110. Switch the initial transmission mode to the adapted transmission mode based on that the adapted transmission mode is different from the initial transmission mode, and designate the adapted transmission mode as the data transmission mode of the corresponding port;
S1111. Instruct the host to transmit data to the connected external device based on the data transmission mode of the port.

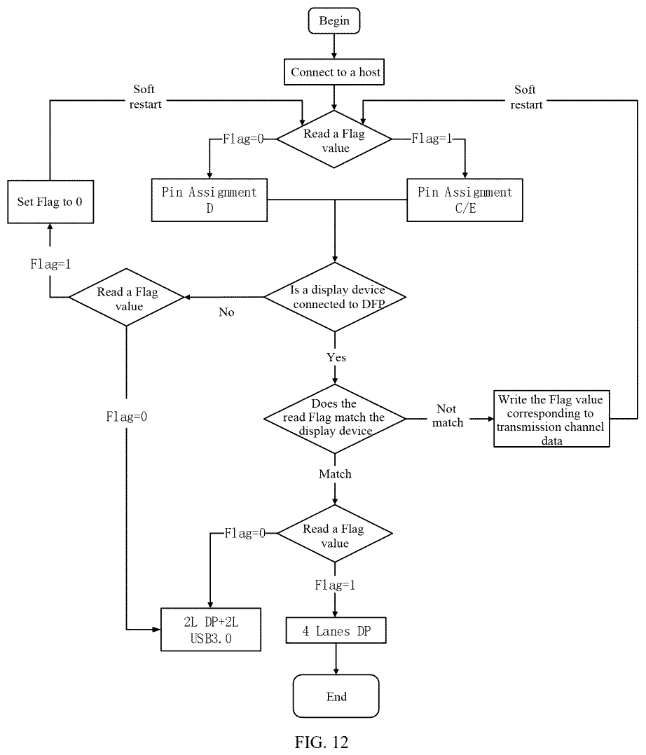

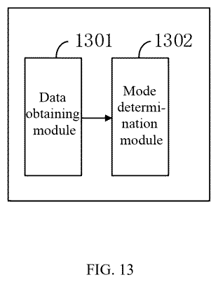

In conjunction with FIG. 12, a general process that the PD controller controls the initial transmission mode is as follows:

After the docking station is connected to the host, the PD controller reads a Flag value. If Flag-0, the PD controller determines that the initial transmission mode is the first display data transmission mode, corresponding to Pin Assignment D. If Flag=1, it is determined that the initial transmission mode is the second display data transmission mode, corresponding to Pin Assignment C/E.

The PD controller determines whether a display device is connected to the DFP. If no display device is connected, the Flag value is read. If Flag=1, the Flag is set to 0, and a soft restart may be performed to update the initial transmission mode. If Flag=0, the PD controller determines that the data transmission mode of the corresponding DFP is the first display data transmission mode (e.g., a 2L DP+2L USB3.0 transmission mode). If the display device is connected, the Flag value is read, and whether the Flag value matches the number of transmission channels of the display device is determined. If the two do not match, the Flag value corresponding to the number of transmission channels of the display device is written, and a soft restart may be performed to update the initial transmission mode. If the two match, the Flag value is read. If Flag-0, the PD controller determines that the data transmission mode of the corresponding DFP is the first display data transmission mode (e.g., 2L DP+2L USB3.0 transmission mode). If Flag=1, the PD controller determines that the data transmission mode of the corresponding DFP is the second display data transmission mode (e.g., 4L DP transmission mode).

Notably, the descriptions in steps S1101-S1111 can be found in the relevant descriptions of the above examples, and their effects are similar. This example will not repeat the descriptions here.

It is to be understood that, although the steps are displayed sequentially according to the instructions of arrows in the flowcharts of the examples described above, these steps are not necessarily performed sequentially according to the sequence instructed by the arrows. Unless otherwise explicitly specified herein, execution of these steps is not strictly limited, but these steps may be performed in other sequences. Moreover, at least some of the steps in the flowchart of each example may include a plurality of steps or a plurality of stages. These steps or stages are not necessarily performed at the same time, but may be performed at different time. Execution of the steps or stages is not necessarily sequentially performed, but may be performed alternately with other steps or at least some of steps or stages of other steps.

Based on the same inventive concept, the examples of the present application further provide a data transmission apparatus for implementing the data transmission method mentioned above. The implementation solution provided by the apparatus to solve the problems is similar to that described in the above method. Therefore, the specific definitions in one or more examples of the data transmission apparatus provided below can refer to the definitions on the data transmission method above, and will not be repeated here.

In one example, as shown in FIG. 13, a data transmission apparatus is provided, including: a data obtaining module 1301 and a mode determination module 1302.

The data obtaining module 1301 is configured to obtain an initial transmission mode of a docking station after being connected to a host, and obtain device information of an external device, the external device being connected to at least one port on the docking station;

The mode determination module 1302 is configured to determine a data transmission mode of the port based on the initial transmission mode and the device information of the external device, so as to instruct the host to transmit data to the connected external device through the data transmission mode of the port.

In one example, the mode determination module 1202 includes: a type submodule, configured to determine a device type of the external device based on the device information of the external device; and a mode submodule, configured to determine the data transmission mode of the port based on the device type of the external device and the initial transmission mode.

In one example, the mode submodule includes: an adaptation unit, configured to determine an adapted transmission mode of the external device based on the device type of the external device; and a mode unit, configured to determine, for the external device, the data transmission mode of the corresponding port based on the adapted transmission mode and the initial transmission mode.

In one example, the mode submodule includes: a requirement subunit, configured to determine a data transmission requirement of the external device based on the device type of the external device; and an adaptation subunit, configured to determine the adapted transmission mode of the external device based on the data transmission requirement of the external device.

In one example, the requirement subunit includes: a first requirement micro unit, configured to determine that the data transmission requirement of the external device is a low data transmission volume when the external device is a non-display device; and a second requirement micro unit, configured to obtain the number of transmission channels from the device information of the external device when the external device is a display device, and determine the data transmission requirement based on the number of transmission channels.

In one example, the second requirement micro unit is further configured to: determine that the data transmission requirement is the low data transmission volume when the number of transmission channels is less than a preset number; or determine that the data transmission requirement is a high data transmission volume when the number of transmission channels is greater than or equal to the preset number, where the high data transmission volume is greater than the low data transmission volume.

In one example, the adapted transmission mode includes a first display data transmission mode or a second display data transmission mode; the data transmission volume of the second display data transmission mode is greater than that of the first display data transmission mode; the adaption subunit includes: a first subunit, configured to determine that the adapted transmission mode is the first display data transmission mode when the data transmission requirement of the external device is the low data transmission volume; and

a second subunit, configured to determine that the adapted transmission mode is the second display data transmission mode when the data transmission requirement of the external device is the high data transmission volume.

In one example, the mode unit includes: a maintaining subunit, configured to maintain the initial transmission mode as the data transmission mode of the corresponding port when the adapted transmission mode is the same as the initial transmission mode; and a switching subunit, configured to switch the initial transmission mode to the adapted transmission mode when the adapted transmission mode is different from the initial transmission mode, and designate the adapted transmission mode as the data transmission mode of the corresponding port.

The various modules in the aforementioned data transmission apparatus can be fully or partially implemented through software, hardware, or a combination thereof. The aforementioned modules may be embedded in or independent of a processor in the docking station in a form of hardware, or stored in a memory of the docking station in a form of software, whereby the processor is called to perform operations corresponding to the modules.

In one example, a docking station is provided, including a charging controller, a USB hub, and a memory. The memory stores a computer program, and the charging controller, when executing the computer program, implements the following steps: obtaining an initial transmission mode of a docking station after being connected to a host, and obtaining device information of an external device, the external device being connected to at least one port on the docking station; determining a data transmission mode of the port based on the initial transmission mode and the device information of the external device, so as to instruct the host to transmit data to the connected external device through the data transmission mode of the port.

In one example, the charging controller, when executing the computer program, further implements the following steps: determining a device type of the external device based on the device information of the external device; and determining the data transmission mode of the port based on the device type of the external device and the initial transmission mode.

In one example, the charging controller, when executing the computer program, further implements the following steps: determining an adapted transmission mode of the external device based on the device information of the external device; and determining, for the external device, the data transmission mode of the corresponding port based on the adapted transmission mode and the initial transmission mode.

In one example, the charging controller, when executing the computer program, further implements the following steps: determining a data transmission requirement of the external device based on the device type of the external device; and determining the adapted transmission mode of the external device based on the data transmission requirement of the external device.

In one example, the charging controller, when executing the computer program, further implements the following steps: determining that the data transmission requirement of the external device is a low data transmission volume when the external device is a non-display device, and/or obtaining the number of transmission channels from the device information of the external device when the external device is a display device, and determining the data transmission requirement based on the number of transmission channels.

In one example, the charging controller, when executing the computer program, further implements the following steps: determining that the data transmission requirement is the low data transmission volume when the number of transmission channels is less than a preset number, and/or determining that the data transmission requirement is a high data transmission volume when the number of transmission channels is greater than or equal to the preset number, where the high data transmission volume is greater than the low data transmission volume.

In one example, the adapted transmission mode includes a first display data transmission mode or a second display data transmission mode; the data transmission volume of the second display data transmission mode is greater than that of the first display data transmission mode; the charging controller, when executing the computer program, further implements the following steps: determining that the adapted transmission mode is the first display data transmission mode when the data transmission requirement of the external device is the low data transmission volume, and/or determining that the adapted transmission mode is the second display data transmission mode when the data transmission requirement of the external device is the high data transmission volume.

In one example, the charging controller, when executing the computer program, further implements the following steps: maintaining the initial transmission mode as the data transmission mode of the corresponding port when the adapted transmission mode is the same as the initial transmission mode, and/or switching the initial transmission mode to the adapted transmission mode when the adapted transmission mode is different from the initial transmission mode, and designating the adapted transmission mode as the data transmission mode of the corresponding port.

In one example, a terminal device is provided, including the aforementioned docking station. The docking station may be integrated into a terminal device.

A person of ordinary skill in the art can understand that all or some of the processes in the methods of the above examples can be implemented by a computer program instructing related hardware. The computer program may be stored in a non-volatile and non-transitory computer-readable storage medium. The computer program, when executed, may include the processes of the examples of the above methods. Any reference to the memory, the database, or other medium used in the examples provided in the present application may all include a non-volatile or volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may be a random access memory (RAM), an external cache, or the like. As an illustration and not a limitation, the RAM can be in many forms, such as a static random access memory (SRAM) or a dynamic random access memory (DRAM). The database involved in each example provided in the present application may include at least one of a relational database and a non-relational database. The non-relational database may include, but is not limited to, a blockchain-based distributed database and the like. The processor involved in each example provided in the present application may be a general-purpose processor, a central processing unit, a graphics processing unit, a digital signal processor, a programmable logic device, a data processing logic device based on quantum computing, and the like, but is not limited to this.

Technical features of the foregoing examples may be combined. To make description concise, not all possible combinations of the technical features in the foregoing examples are described. However, the combinations of these technical features are considered as falling within the scope recorded by this specification provided that no conflict exists.

The aforementioned examples show only several implementations of the present application and are described in detail, which, however, are not to be construed as a limitation to the patent scope of the present application. It should be noted that those of ordinary skill in the art can make some variations and improvements without departing from the concept of the present application, and these variations and improvements all fall into the protection scope of the present application. Therefore, the scope of protection of the present application should be subject to the appended claims.

What is claimed is:

1. A data transmission method, comprising:
obtaining, by a docking station, an initial transmission mode of the docking station connected to a host device;
obtaining device information of a computing device connected to a port of the docking station;
determining a data transmission mode of the port based on the initial transmission mode and the device information of the computing device; and
sending an instruction to the host device to transmit, based on the data transmission mode of the port, data from the host device to the computing device.

2. The data transmission method according to claim 1, wherein the determining the data transmission mode of the port comprises:
determining a device type of the computing device based on the device information of the computing device; and
determining the data transmission mode of the port based on the device type of the computing device and the initial transmission mode.

3. The data transmission method according to claim 2, wherein the determining the data transmission mode of the port based on the device type of the computing device and the initial transmission mode comprises:
determining an adapted transmission mode of the computing device based on the device type of the computing device, wherein the device type of the computing device indicates that the computing device is one of a display device, a storage device, or a power adapter; and
determining the data transmission mode of the port based on the adapted transmission mode and the initial transmission mode.

4. The data transmission method according to claim 3, wherein the determining an adapted transmission mode of the computing device based on the device type of the computing device comprises:
determining a data transmission requirement of the computing device based on the device type of the computing device; and
determining the adapted transmission mode of the computing device based on the data transmission requirement of the computing device.

5. The data transmission method according to claim 4, wherein the determining the data transmission requirement of the computing device comprises:
determining that the data transmission requirement of the computing device is a low data transmission volume based on determining that the computing device is not a display device.

6. The data transmission method according to claim 5, wherein the determining the data transmission requirement of the computing device comprises:
obtaining a number of transmission channels from the device information of the computing device, and determining the data transmission requirement based on the number of transmission channels.

7. The data transmission method according to claim 6, wherein the determining the data transmission requirement based on the number of transmission channels comprises:
determining that the data transmission requirement is the low data transmission volume based on that the number of transmission channels is less than a preset number; and
determining that the data transmission requirement is a high data transmission volume based on that the number of transmission channels is greater than or equal to the preset number, wherein the high data transmission volume is greater than the low data transmission volume.

8. The data transmission method according to claim 4, wherein the adapted transmission mode comprises a first display data transmission mode associated with a low data transmission volume of the computing device, and a second display data transmission mode associated with a high data transmission volume of the computing device.

9. The data transmission method according to claim 3, wherein the determining the data transmission mode of the port based on the adapted transmission mode and the initial transmission mode comprises:
maintaining the initial transmission mode as the data transmission mode of the port based on determining that the adapted transmission mode is the same as the initial transmission mode; and
switching the initial transmission mode to the adapted transmission mode based on determining that the adapted transmission mode is different from the initial transmission mode, and designating the adapted transmission mode as the data transmission mode of the port.

10. A data transmission apparatus, comprising:
one or more processors; and
memory storing instructions that, when executed by the one or more processors, cause the data transmission apparatus to:
obtain an initial transmission mode of a docking station connected to a host device;
obtain device information of a computing device connected to a port of the docking station;
determine a data transmission mode of the port based on the initial transmission mode and the device information of the computing device; and
send an instruction to the host device to transmit, based on the data transmission mode of the port, data from the host device to the computing device.

11. The data transmission apparatus according to claim 10, wherein the instructions, when executed by the one or more processors, cause the data transmission apparatus to determine the data transmission mode of the port by:
determining a device type of the computing device based on the device information of the computing device; and
determining the data transmission mode of the port based on the device type of the computing device and the initial transmission mode.

12. The data transmission apparatus according to claim 11, wherein the instructions, when executed by the one or more processors, cause the data transmission apparatus to determine the data transmission mode of the port based on the device type of the computing device and the initial transmission mode by:
determining an adapted transmission mode of the computing device based on the device type of the computing device; and
determining the data transmission mode of the port based on the adapted transmission mode and the initial transmission mode.

13. The data transmission apparatus according to claim 12, wherein the instructions, when executed by the one or more processors, cause the data transmission apparatus to determine an adapted transmission mode of the computing device based on the device type of the computing device by:
determining a data transmission requirement of the computing device based on the device type of the computing device; and
determining the adapted transmission mode of the computing device based on the data transmission requirement of the computing device.

14. The data transmission apparatus according to claim 13, wherein the instructions, when executed by the one or more processors, cause the data transmission apparatus to determine the data transmission requirement of the computing device by determining that the data transmission requirement of the computing device is a low data transmission volume based on determining that the computing device is not a display device.

15. The data transmission apparatus according to claim 14, wherein the instructions, when executed by the one or more processors, cause the data transmission apparatus to determine the data transmission requirement of the computing device by obtaining a number of transmission channels from the device information of the computing device, and determining the data transmission requirement based on the number of transmission channels.

16. The data transmission apparatus according to claim 15, wherein the instructions, when executed by the one or more processors, cause the data transmission apparatus to determine the data transmission requirement based on the number of transmission channels by:
determining that the data transmission requirement is the low data transmission volume based on that the number of transmission channels is less than a preset number; and
determining that the data transmission requirement is a high data transmission volume based on that the number of transmission channels is greater than or equal to the preset number, wherein the high data transmission volume is greater than the low data transmission volume.

17. The data transmission apparatus according to claim 13, wherein the adapted transmission mode comprises a first display data transmission mode associated with a low data transmission volume of the computing device, and a second display data transmission mode associated with a high data transmission volume of the computing device.

18. The data transmission apparatus according to claim 12, wherein the instructions, when executed by the one or more processors, cause the data transmission apparatus to determine the data transmission mode of the port based on the adapted transmission mode and the initial transmission mode by:
maintaining the initial transmission mode as the data transmission mode of the port based on determining that the adapted transmission mode is the same as the initial transmission mode; and
switching the initial transmission mode to the adapted transmission mode based on determining that the adapted transmission mode is different from the initial transmission mode, and designating the adapted transmission mode as the data transmission mode of the port.

19. A non-transitory computer-readable medium storing instructions that, when executed, cause:
obtaining an initial transmission mode of a docking station connected to a host device;
obtaining device information of a computing device connected to a port of the docking station;
determining a data transmission mode of the port based on the initial transmission mode and the device information of the computing device; and
sending an instruction to the host device to transmit, based on the data transmission mode of the port, data from the host device to the computing device.

20. The non-transitory computer-readable medium according to claim 19, wherein the instructions, when executed, cause the determining the data transmission mode of the port by causing:
determining a device type of the computing device based on the device information of the computing device; and
determining the data transmission mode of the port based on the device type of the computing device and the initial transmission mode.
